(19) United States
(12) Patent Application Publication
(10) Pub. No.: US 2007/0205207 A1
(43) Pub. Date: Sep. 6, 2007

(54) Aperture plug with a removable paint mask

(75) Inventor: David A. Dornbach, Waukesha, WI (US)

Correspondence Address: QUARLES & BRADY LLP, 411 E. WISCONSIN AVENUE, SUITE 2040, MILWAUKEE, WI, 53202-4497, US

(73) Assignee: HUSCO International, Inc.

(21) Appl. No.: 11/367,916

(22) Filed: Mar. 3, 2006

(51) Int. Cl. B65D 43/04; F16L 55/10; B05C 11/11

(52) U.S. Cl. 220/803; 138/89.4; 118/505

(57) ABSTRACT

A plug is provided for temporarily closing an aperture of a manufactured article prior to use to protect against debris entering the aperture. The plug has a first portion that fits into the aperture and a second portion that extends outside the aperture covering part of the exterior surface of the manufactured article. A band, serving as a paint mask, is attached to and extends radially outward from the exterior perimeter of the second portion, thereby further covering the exterior surface of the manufactured article. The plug is inserted into the aperture prior to painting and the band is torn away from the remainder of the plug after painting. The remainder of the plug can be removed after the paint has completely dried without producing paint particles which could contaminate the workplace or fall into the aperture.

### CROSS-REFERENCE TO RELATED APPLICATIONS

Not Applicable

### STATEMENT REGARDING FEDERALLY SPONSORED RESEARCH OR DEVELOPEMENT

Not Applicable

### BACKGROUND OF THE INVENTION

1. Field of the Invention

The present invention relates to plugs for temporarily closing apertures in a manufactured article to prevent contaminates from entering the aperture during transportation and storage prior to use; and more particularly to such plugs that prevent paint from entering the apertures when the article is painted.

2. Description of the Related Art

Hydraulic systems are controlled by valves that are inserted into a manifold through which hydraulic fluid is routed to and from the valves. For example, the manifold has an inlet aperture to which a hose from a hydraulic pump is connected for supplying pressurized fluid to the valves. Passages through the manifold lead from the inlet aperture to other apertures in which the valves are inserted. Other passages lead from those valve apertures to workport apertures to which hydraulic actuators, such as cylinders and motors, are connected. Fluid returning from the hydraulic actuators enters the manifold at different workport apertures connected to a return passage to an outlet aperture that is connected to the fluid reservoir of the hydraulic system.

A typical manifold is cast from metal and then machined to form the various apertures. Thereafter fabrication of the manifold is completed by painting the exterior surfaces. The finished manifold is stored and then shipped to a manufacturer of machinery that utilizes it as part of a hydraulic system.

During painting, storage and shipping, the apertures of the manifold are closed by temporary plugs to prevent paint and debris from entering and subsequently contaminating the hydraulic system into which the manifold is assembled. Typically, the temporary plugs are made of plastic which are either pushed or threaded into the apertures to secure them in place. The plugs are removed upon assembly of the manifold into the hydraulic system.

When the customer receives the painted manifold, the plugs are removed and proper hydraulic fittings are installed. In the course of removing the plugs, paint shards are created as the plug pulls the paint away at the interface between the edge of the plug and the surface of the manifold. The paint shards often contaminate the work space at which the plugs are removed. Because this work space may also be the place at which the various hydraulic components are connected to the manifold, the shards can enter those hydraulic components, thus contaminating the hydraulic system being assembled.

Therefore, it is desirable to provide a device for closing the apertures of a manufactured article in a manner does generate paint shards upon removal of the plugs during subsequent assembly of the article with other components.

### SUMMARY OF THE INVENTION

A plug is provided for closing an aperture of a manufactured article prior to use to protect against debris entering the aperture. The plug includes a first portion that is arranged to fit into the aperture and secure the plug therein. A second portion is attached to the end of the first portion and has an exterior perimeter that fits outside the manufactured article. A band is attached to and extends radially outward from the exterior perimeter of the second portion, and is adapted to tear away from the second portion.

The plug is inserted into the aperture prior to painting and serves as a paint mask by covering part of the exterior surface of the manufactured article around the aperture. After painting, the band is torn away from the remainder of the plug, preferably before the paint has completely dried. The article then can be stored and shipped to a customer. The customer can remove the remainder of the plug after the paint has completely dried without producing paint particles which could contaminate the workplace.

### BRIEF DESCRIPTION OF THE DRAWINGS

FIG. 1 is a view of a hydraulic manifold with apertures in which temporary plugs, according to the present invention, have been inserted;

FIG. 2 is an isometric view of the temporary plug with a paint mask band;

FIG. 3 is a cross sectional view showing an aperture in the hydraulic manifold and the temporary plug inserted therein;

FIG. 2 is an isometric view of the temporary plug showing the paint mask band partially removed; and

FIG. 5 is a partial cross sectional view similar to FIG. 2 in which a paint mask band has been completely removed from the temporary plug.

### DETAILED DESCRIPTION OF THE INVENTION

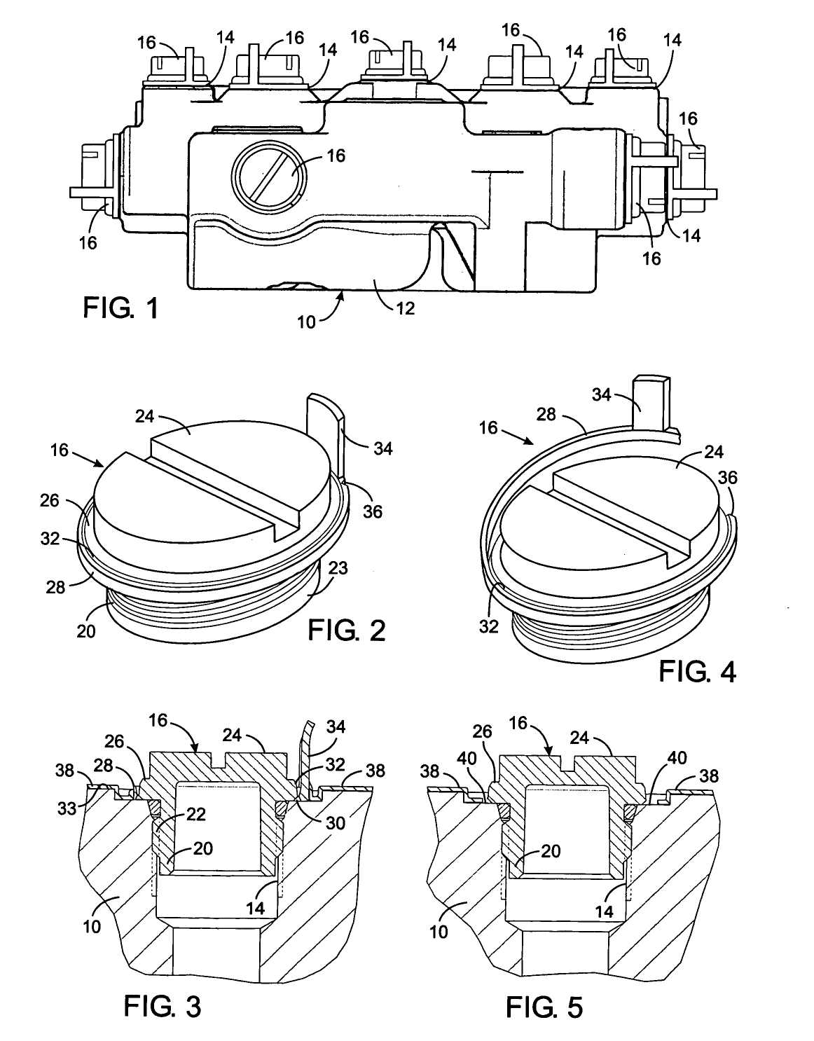

FIG. 1 illustrates an exemplary manufactured article in the form of a manifold 10 for a hydraulic valve assembly. The manifold is a steel casting in which a plurality of apertures 14 have been formed either by the casting process or subsequent machining. After the manifold 10 has been fabricated, a plug 16 is inserted into each of the apertures 14 to prevent debris from entering which could subsequently contaminate the hydraulic system that utilizes the manifold body. The plugs 16 also protect the apertures during painting of the manufactured article. Various apertures ultimately will receive cartridge valves, pressure relief valves, and fittings of conduits that carry fluid to and from the manifold. Passages within the manifold interconnect the various apertures in a defined manner.

With reference to FIGS. 2 and 3, each plug 16 comprises a cylindrical body 20 with an integral cap 24 at one end. A flange 26 that projects radially outward from the cap 24 and beyond an outer circumferential surface 23 of the cylindrical body 20. External screw threads 22, formed on an outer circumferential surface 23 of the cylindrical body 20, mate with threads in a manifold aperture 14, thereby securing plug in place. Alternatively, the thread may be omitted from the plug body 20 in which case is sized to snuggly fit within the manifold aperture. With either construction, the plug 16 is inserted into the aperture 14 until the flange 26 contacts the surface of the manifold around the aperture.

The flange 26 has a circumferential perimeter around which a removable band 28 extends. A weakened area is provided at the interface between the band 28 and the perimeter of the cap 24 that allows the band to tear away from the cap, as will be described. Specifically, a first score line 30 in the form of a V-shaped groove extends in a circle around the perimeter of the cap on the bottom side of the band 28 that is proximate to the body 20 of the plug. A second score line 32 extends around the perimeter of the cap on the upper surface of the flange 26 on the side of the band 28 that is remote from the body 20. The two score lines 30 and 32 are directly opposite each another providing a relatively thin piece of material there between by which the band 28 is attached to the perimeter of the cap 24. The band 28 has a pull tab 34 that projects upward above the top surface of the cap.

The plugs 16 are used to close the apertures 14 following the metal forming operations on the manifold 10. Specifically, after the apertures 14 have been machined, a plastic plug 16 is screwed into each aperture so that the bottom surface of the flange 26 abuts the exterior surface 33 of the exterior manifold 10, as shown in FIG. 3. The flange 26 and the band 28 cover a portion of the exterior manifold surface around the aperture 14.

The manifold 10 then is sprayed with paint that forms a coating 38 on the exterior surface 33. The paint also covers at least part of the exposed surfaces of the plugs 16.

With continuing reference to FIGS. 2 and 3, after the paint has partially dried, but while it is still in a soft state, a person grasps the tab 34 of the plug between two fingers and then bends the tab downward to break the band at a vertical notch 36. The tab 34 then is pulled outward with a circular motion that causes the band 28 tear away from the perimeter of the cap 24, as shown in FIG. 4. That action breaks the small amount of material that exists between the two score lines 30 and 32, enabling the band easily to tear free of the remainder of the cap. Because the paint coating 38 is still relatively soft, it will severe neatly at the interface between the manifold 10 and the band 28 without producing shards or other particles of paint as may occur if the band is removed after the paint has dried completely.

When the band has been fully removed from the cap 24, a small gap 40 exists between the paint and perimeter of the flange 26 of the plug 16, as seen in FIG. 4. This gap 40 allows the plug 16 to be removed subsequently from the aperture 14 after the paint has fully dried without tearing the surface of the paint and producing shards or particles that could fall into the then opened aperture. Thus, contamination of the hydraulic system by such paint shards or particles has been avoided.

In some cases, the manufacturer of the manifold 10 applies only a coat of primer paint. The purchaser of the manufactured article applies the finish coat of paint in the desired color. In this situation, the manufacturer of the manifold does not remove the bands 28 from the plugs 16, but ships the article to the purchaser with the bands in place. Once the purchaser has applied the finish coat of paint, the bands 28 can be removed before that outer finish coat of paint has completely dried. Because the finish coat of paint is relatively soft at that time, any particles of the primer coat will be removed integrally with the finish coat material that adheres to the plug band.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A plug for temporally closing an aperture of a manufactured article, said plug comprising:
a first portion arranged to fit removably into the aperture and engage a surface of the aperture to secure the plug therein;
a second portion integral with the first portion and having an exterior perimeter; and
a band attached to and extending around the exterior perimeter of the second portion so as to cover a section of an exterior surface of the manufactured article when the plug is inserted into the aperture, and the band being adapted to tear away from the second portion.

2. The plug as recited in claim 1 further comprising a pull tab attached to the band for grasping by a user to tear the band away from the second portion.

3. The plug as recited in claim 1 wherein the first portion has exterior threads for engaging threads in the aperture.

4. The plug as recited in claim 1 wherein the second portion comprises a flange which projects radially outward from the first portion and forming the exterior perimeter.

5. The plug as recited in claim 1 wherein first portion is a circular cylinder having an outer circumferential surface.

6. The plug as recited in claim 5 wherein second portion projects radially outward beyond the outer circumferential surface of the first portion.

7. The plug as recited in claim 1 wherein the band has a notch which facilitates breaking the band for removal from the second portion.

8. The plug as recited in claim 1 further comprising a weakened area between the exterior perimeter and the band.

9. The plug as recited in claim 1 wherein the plug is scored along a first score line that extends along the exterior perimeter and on a side of the band that is proximate to the first portion.

10. The plug as recited in claim 9 wherein the plug is scored along a second score line that extends along the exterior perimeter and on a side of the band that is remote from the first portion.

11. The plug as recited in claim 1 wherein the plug is scored along a score line that extends along the exterior perimeter and the band on a side of the band that is remote from the first portion.

12. A plug for an aperture of a manufactured article, said plug comprising:
a body arranged to fit into the aperture and engage a surface of the aperture to secure the plug therein;
a cap attached to and extending radially outward from one end of the body, the cap having an exterior perimeter; and
a band attached to and extending around the exterior perimeter of the cap and being adapted to tear away there from.

13. The plug as recited in claim 12 further comprising a pull tab attached to the band for grasping by a user for tearing the band away from the cap.

14. The plug as recited in claim 12 wherein the body has exterior threads for engaging threads in the aperture.

15. The plug as recited in claim 12 further comprising a weakened area between the exterior perimeter of the cap and the band.

16. The plug as recited in claim 12 wherein the plug is scored along a first score line that extends along the exterior perimeter of the cap and on a side of the band that is proximate to the body.

17. The plug as recited in claim 16 wherein the plug is scored along a second score line that extends along the exterior perimeter of the cap and on a side of the band that is remote from the body.

18. The plug as recited in claim 12 wherein the plug is scored along a score line that extends along the exterior perimeter of the cap and the band on a side of the band that is remote from the body.

19. A method preventing debris from entering an aperture in a manufactured article, said method comprising:
inserting a plug into the aperture prior to painting the manufactured article, wherein the plug has a first portion that removably fits into the aperture and engages a surface of the aperture to secure the plug therein, and has a second portion with an exterior perimeter around which a removable band extends and covers a section of an exterior surface of the manufactured article; and
after the manufactured article has been painted, removing the band from the second portion of the plug while leaving the first portion of the plug inserted in the aperture.

20. The method as recited in claim 19 further comprising removing the plug from the aperture subsequent to removal of the band.
